(19) United States
(12) Patent Application Publication
(10) Pub. No.: US 2013/0328964 A1
(43) Pub. Date: Dec. 12, 2013

(54) APPARATUS FOR PRODUCING THREE-DIMENSIONAL PRODUCT

(71) Applicants: YU-CHOU YEH, TAOYUAN COUNTY (TW); TING-CHING LIN, TAOYUAN COUNTY (TW); CHAO-YI WANG, TAOYUAN COUNTY (TW)

(72) Inventors: YU-CHOU YEH, TAOYUAN COUNTY (TW); TING-CHING LIN, TAOYUAN COUNTY (TW); CHAO-YI WANG, TAOYUAN COUNTY (TW)

(73) Assignee: J TOUCH CORPORATION, TAOYUAN COUNTY (TW)

(21) Appl. No.: 13/490,415

(22) Filed: Jun. 6, 2012

(51) Int. Cl. B41J 2/015

(52) U.S. Cl. 347/20

(57) ABSTRACT

Disclosure is related to an apparatus for producing a three-dimensional product. Apparatus is configured to print a 3D image onto a flat surface of grating film. The grating film has the flat surface and a grating textural surface. In an exemplary example, the apparatus includes an image capturing unit for generating an object image by photographing an object. A control unit is also included for extracting the object from the object image and regarding it as a foreground object image. Afterward, the foreground object image is combined with a background image, and a 3D picture is formed. The background image is stored in a background image storing unit. A printing unit is included for printing the combined three-dimensional image onto a flat surface of grating film. A bottom-layer forming unit is used to form an opaque layer onto the grating film printed with the three-dimensional image.

### BACKGROUND

1. Technical Field

The present invention relates to an apparatus for producing a three-dimensional product, more particularly to the apparatus for producing a three-dimensional picture.

2. Description of Related Art

A technology for outputting a three-dimensional picture has been disclosed in the conventional art, such as R.O.C. Patent Application No. 098130523 providing a method for printing a 3D picture and a relevant apparatus. The conventional technology includes making a grating structure onto a surface of a protective zone of a color strip, in which the color strip includes a plurality of dye areas and the protective zone. The method includes a next step of receiving a target image, and then moving a printing medium. When the printing medium is moved, the step in the method is to transfer the plurality of dye areas onto the printing medium based on the target image. The next step in the method is to transfer the protective zone of the color strip onto the printing medium after the dye areas are transferred to the printing medium. Otherwise, this conventional art fails to conduct the 3D picture onto any medium such as grating structure directly. The technology may not provide any convenient tool for people to output the three-dimensional image.

Other features, elements, arrangements, steps, characteristics and advantages according to this invention will be readily understood from the detailed description of the preferred embodiment in conjunction with the accompanying drawings.

The above description should not be deemed to limit the scope of this invention, which should be properly determined on the basis of the attached claims

### SUMMARY

In view the conventional technology lack of effective process to producing the 3D article, disclosed is an apparatus for producing a three-dimensional product which provides a great improvement thereof

One of the objectives of the present invention is to provide an apparatus for producing a three-dimensional product and the apparatus is able to directly print a three-dimensional image onto the surface of a grating film. An opaque layer acts as a bottom layer formed onto the grating film so as to either protect the combined three-dimensional image or to enhance the 3D effect as viewing the image.

For achieving the objective, an apparatus for producing a three-dimensional product in accordance with the present invention is provided. In an exemplary example, a three-dimensional image in combination is printed onto a flat surface of the grating film. The grating film includes the flat surface and a grating textural surface which is disposed opposite to the flat surface. The apparatus includes an image capturing unit for capturing an object as a corresponding object image. The apparatus also includes a control unit which is operated onto the object image for generating a foreground object image being extracted from the object. Further, the control unit of the apparatus is adapted to combine the foreground object image and a background image. A three-dimensional image is therefore formed as conducting the combination of the foreground and background images. The apparatus includes a background image storing unit, which stores one or more background images. The apparatus includes a printing unit, and thereby the combined three-dimensional image is printed onto the flat surface of the grating film. A bottom-layer forming unit is also included for forming an opaque layer on to the grating film on which the combined three-dimensional image is printed.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a structural diagram of the apparatus for producing a three-dimensional product in accordance with the present invention;

FIG. 2A shows a three-dimensional diagram of the grating film not yet printed with the combined three-dimensional image;

FIG. 2B shows another view of the three-dimensional diagram of the grating film not with the three-dimensional image;

FIG. 3 shows a schematic example of the combined three-dimensional image processed by the control unit in accordance with the present invention;

FIG. 4 is a schematic diagram showing a process of the apparatus for producing three-dimensional product using the grating film in accordance with the present invention;

FIG. 5 is a lateral view of the grating film printed with the combined three-dimensional image made by the apparatus for producing the three-dimensional product.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

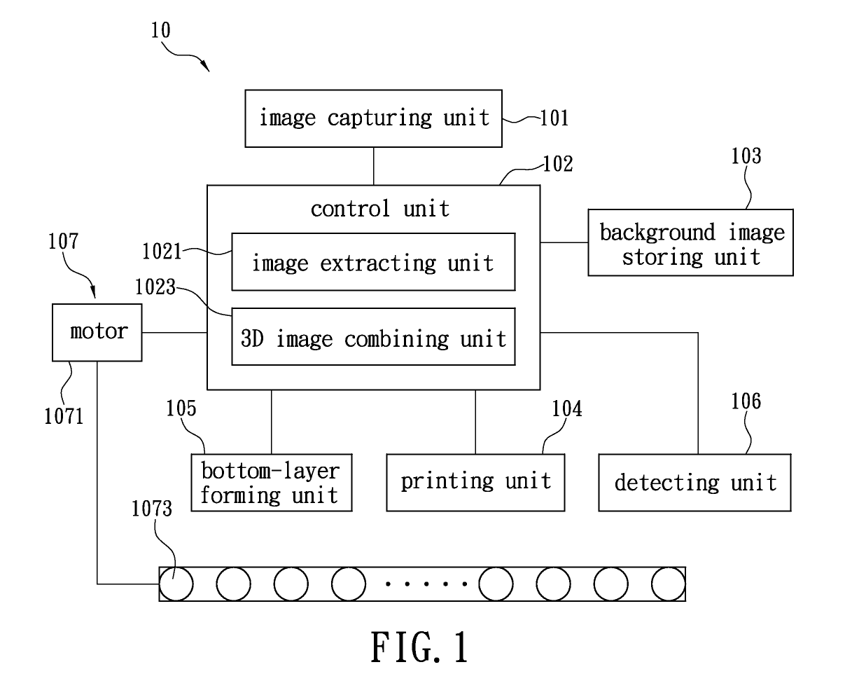

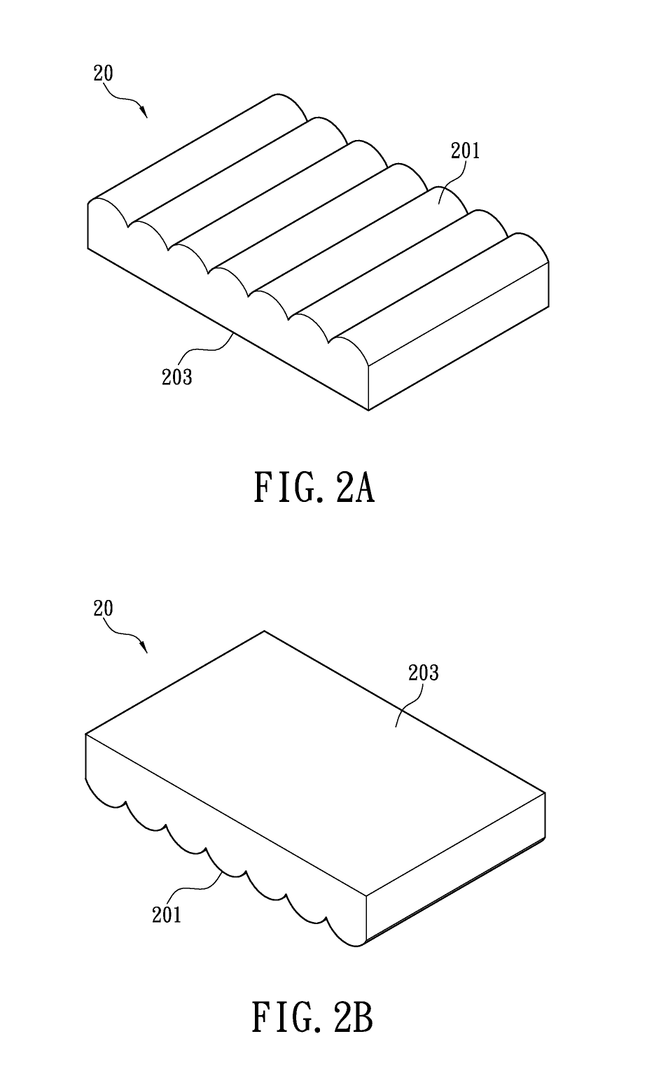

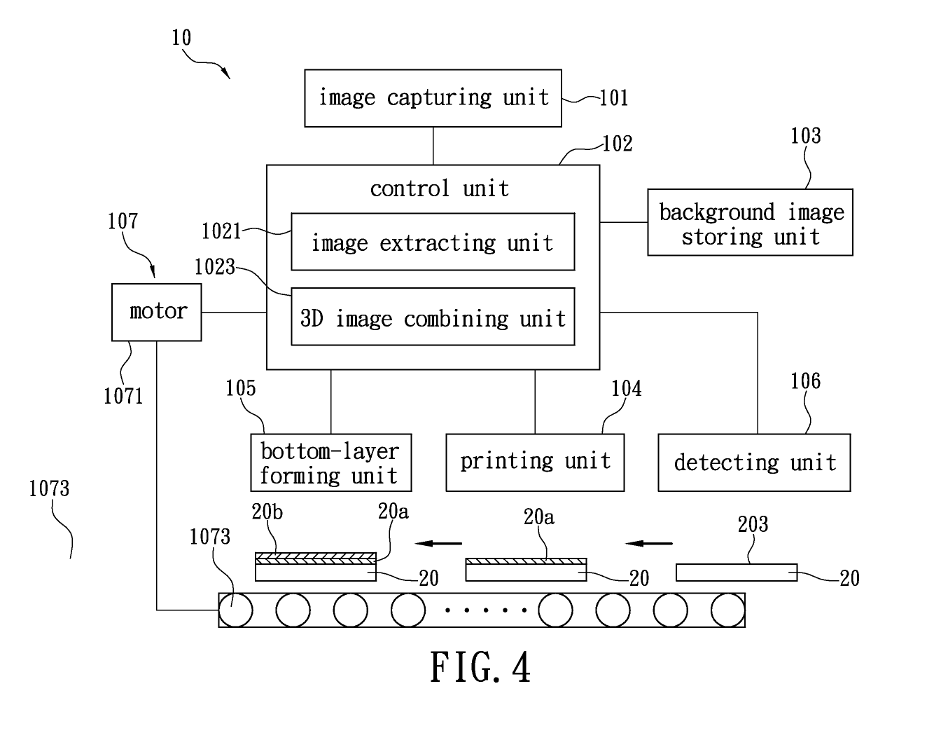

References for the present invention are made to FIGS. 1 through 5. One of the functionalities of the apparatus for producing a three-dimensional product 10 in accordance with the present invention is to produce a three-dimensional picture. An exemplary embodiment of the apparatus 10 is such as a machine for producing a three-dimensional photo sticker. The apparatus of the present invention employs a grating film 20 having surface grating structure. The film 20 is such as the types shown in FIGS. 2A-2B. The grating film 20 is provided to assist the apparatus to produce the picture with three-dimensional viewing effect. The shown grating textural surface 201 of the grating film 20 is composed of continuous semi-circle cylindrical lens over the whole plane. On the other hand, the other surface of the grating film 20 is still a flat surface 203. The apparatus for producing a three-dimensional product 10 essentially includes an image capturing unit 101, a control unit 102, a background image storing unit 103, a printing unit 104, and a bottom-layer forming unit 105, and their descriptions are as follows.

The image capturing unit 101 is served to photograph an object to be an object image. The image capturing unit 101 is such as a digital camera, or other similar capturing device which uses the photosensitive element made of CMOS (complementary-symmetry metal-oxide-semiconductor) or CCD (Charge-coupled Device). The object is such as any person, article, animal, plant or the like. The object may be positioned in front of the image capturing unit 101, and to be photographed. The image capturing unit 101 then generates the object image after photographing the object. Afterward, the object image is output to the control unit 102. The photographing scene is preferred to be a monochromatic color for extracting the object from the scene.

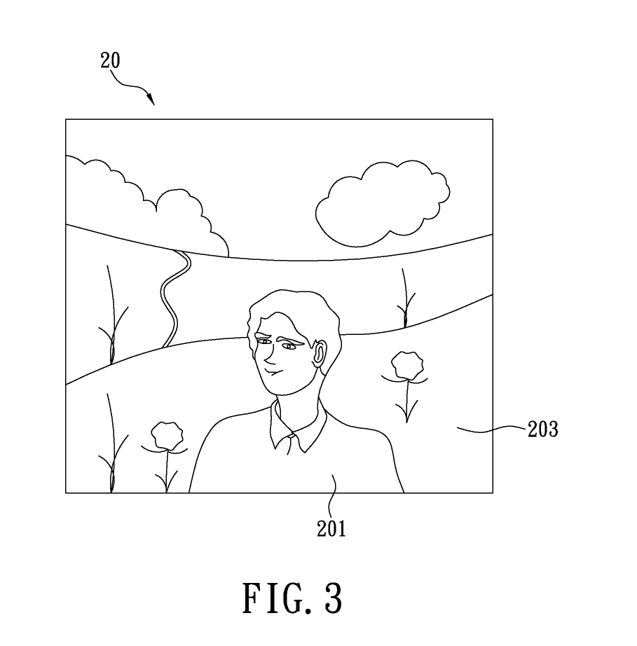

The control unit 102 is served to process the object image, for example to extract the object from the image. The extracting process is performed onto the image to form a foreground object image 201. The control unit 102 is also functioned to combine the foreground object image 201 and the specified background image 203 so as to form a combined three-dimensional image 20a. Further, the control unit 102 allows the apparatus to specify the background image 203 from the background image storing unit 103, or to access any image rather than the background image 203. In an exemplary embodiment, the control unit 102 further includes an image extracting unit 1021 and a three-dimensional image combining unit 1023.

In which, this image extracting unit 1021 is used to remove the background portion from the object image, and merely take out the object. For example, the unit 1021 can extract the person, article, animal, plant or the like from the image which may involve any specified object. Exemplarily, the person object shown in FIG. 3 has been extracted from its original image. The object is then processed to be the foreground object image 201.

Furthermore, the three-dimensional image combining unit 1023 is particularly used to combine the foreground object image 201 and the background image 203 in order to form the combined three-dimensional image 20a. According to the predetermined depth of field of the object, basic parameters of the grating film 20 and the printing unit 104, the three-dimensional image combining unit 1023 is specifically to form the three-dimensional product by combining the foreground and background object images 201, 203. The process to form the three-dimensional product may include some steps such as positioning the foreground and background images oppositely, down-scaling, and staggering the sampled image. The combined three-dimensional image 20a adapted to be printed onto the grating film 20 is consequently produced.

In an exemplary embodiment, the image extracting unit 1021 and the three-dimensional image combining unit 1023 may be operated in accordance with the conventional technologies made by the skilled person in the art. Alternatively, the means to implement the image extraction or the image combination may be embodied by the conventional image processing software, the related image processing firmware, or any other functional hardware.

The background image storing unit 103 is served to store one or more mentioned background images 203. Those background images 203 may be different. The background image storing unit 103 is exemplarily the system memory, memory card, hard disk, or other like storage. The background image 203 may be exemplarily made by photographing multiple pictures with various views of angle by sliding a single-lens digital camera. A kind of multiple-lens digital camera may be used to take the plurality of pictures. Still further, the single picture may be produced by converting the 2D image into a 3D image by a converting program. The mentioned number of the pictures may indicate the number of viewing angles.

The printing unit 104 is operated to print the combined three-dimensional image 20a onto the flat surface 203 of grating film 20. A conventional thermal-transfer printing device may embody the printing unit 104.

The bottom-layer forming unit 105 is served to form the opaque layer 20b onto the grating film 20 printed with the three-dimensional image 20a. An ink-jet printer may embody this printing unit 104. The printer allows the opaque color materials to form the opaque layer 20b. A stamping machine may also be used to stamp the opaque color materials for forming the opaque layer 20b. A coating machine may coat the opaque color materials onto the surface of the product as the opaque layer 20b.

The apparatus for producing a three-dimensional product 10 in accordance with one of the embodiments may further include a detecting unit 106 for detecting whether or not the grating film 20 is correctly positioned in the apparatus 10. The detecting unit 106 can be implemented by an infrared detection device. This infrared detection device is exemplarily disposed at an original progressive path of the grating film 20. The device can determine whether or not the grating film 20 is placed at right position of the apparatus 10 by detecting if its infrared ray is blocked by the grating film 20.

The apparatus for producing a three-dimensional product 10 also includes a delivering unit 107 which is used to deliver the grating film 20 to the right position. The grating film 20 at least delivers the printing unit 104 and the bottom-layer forming unit 105 in the exemplary embodiment. The delivering unit 107 further includes a motor 1071 and a plurality of rolls 1073. The rolls 1073 are driven by the motor 1071 and driving the grating film 20 to move on.

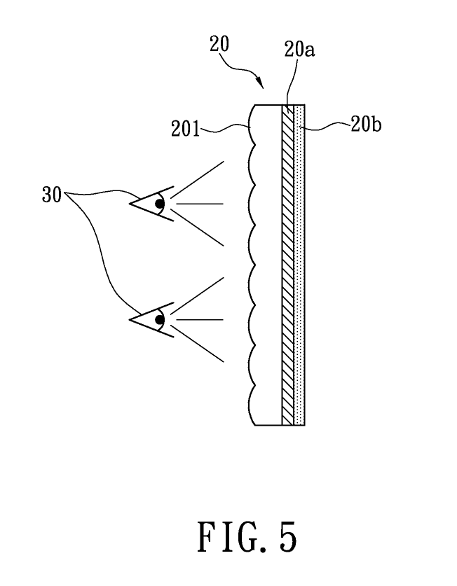

Reference is made to FIG. 5, the combined three-dimensional image 20a is sandwiched in between the layers including the grating film 20. The light reflected from the vision of the image 20a passes across the grating textural surface 201 of the grating film 20 and reaches the eyes 30. Different viewing angles make the different images separately formed in the left and right eyes, and therefore result in the 3D viewing effect.

The mentioned grating film 20 may use the conventional grating film, and its material is preferred high transparency.

In summation, the apparatus (10) for producing a three-dimensional product in accordance with the present invention allows the combined three-dimensional image (20a) to be formed onto the surface of grating film (20). It is advantageous to the present invention that an opaque layer (20b) is particularly formed at the bottom layer thereof for protecting the three-dimensional product. Furthermore the opaque layer (20b) also enhances the 3D viewing effect because of the opaque layer 20b may not allow much light entering the grating film (20) from its bottom layer.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. An apparatus for producing a three-dimensional product, operatively for printing a three-dimensional image onto a flat surface of a grating film, wherein the grating film has a grating textural surface opposite to the flat surface, the apparatus comprising:
an image capturing unit, for generating an object image by photographing an object;
a control unit, for generating a foreground object image by processing the object extracted from the object image, and combining the foreground object image with a background image so as to form the three-dimensional image;
a background image storing unit, for storing one or more background images;
a printing unit, for printing the combined three-dimensional image onto the flat surface of the grating film; and
a bottom-layer forming unit, for forming an opaque layer upon the grating film printed with the combined three-dimensional image.

2. The apparatus according to claim 1, further comprising a detecting unit for detecting whether or not the grating film is placed in the apparatus for producing the three-dimensional product.

3. The apparatus according to claim 1, further comprising a delivering unit for delivering the grating film to passing across the printing unit and the bottom-layer forming unit.

4. The apparatus according to claim 1, wherein the image capturing unit is a digital camera, or a capturing device implemented by a CMOS photosensitive element or a CCD photosensitive element.

5. The apparatus according to claim 1, wherein the control unit comprises:
an image extracting unit, for extracting the object from the object image, and processing the object to be the foreground object image; and
a three-dimensional image combining unit, for combining the foreground object image and the background image, so as to form the combined three-dimensional image.

6. The apparatus according to claim 3, wherein the delivering unit includes a motor and a plurality rolls, and the rolls are driven to roll by the motor.

7. The apparatus according to claim 1, wherein the printing unit is a thermal-transfer printing device.

8. The apparatus according to claim 1, wherein the bottom-layer forming unit is an ink-jet printer used to print an opaque color material to be an opaque layer, or a stamping machine for stamping the opaque color material to form the opaque layer, or a coating machine for coating the opaque color material to form the opaque layer.
